(19) United States
(12) Patent Application Publication
(10) Pub. No.: US 2016/0075441 A1
(43) Pub. Date: Mar. 17, 2016

(54) AERIAL REFUELING NAVIGABLE DEVICE, SYSTEM AND METHOD

(71) Applicant: Ziad Ahmed Mohamed Ali Hussein Elsawah, Toronto (CA)

(72) Inventor: Ziad Ahmed Mohamed Ali Hussein Elsawah, Toronto (CA)

(21) Appl. No.: 14/484,783

(22) Filed: Sep. 12, 2014

(51) Int. Cl. B64D 39/04; B64D 39/06

(52) U.S. Cl. CPC B64D 39/04; B64D 39/06

(57) ABSTRACT

A device, system, and method for facilitating aerial refueling. The device is a navigable flying unit for more precise positioning to establish a fuel-transmitting connection with a fuel inlet of a fuel-receiving plane (including a fuel inlet located on the wing of a commercial aircraft). The device comprises controllable aerodynamic surfaces for mid-air maneuvering while attached to a fuel-transmitting medium being trailed by a fuel-giving plane. The navigable unit may also comprise a means for, if necessary, moving along a surface of the fuel-receiving plane for more precise positioning, and a means for attaching to the surface of the fuel-receiving plane and/or a fuel port thereof, as well as a means for coupling with the fuel inlet in order to establish a fuel-transmitting connection. The in-air maneuvering of the device and fuel-transmitting medium may be facilitated in one embodiment, by the fuel-transmitting medium comprising aerodynamic surfaces configured for reducing drag.

### FIELD OF INVENTION

The present invention is in the technical field of aviation and more particularly relates to aerial refueling devices, methods, and systems.

### BACKGROUND OF INVENTION AND DESCRIPTION OF PRIOR ART

Prior art aerial refueling methods and devices have not provided adequate solutions for aerial refueling of commercial aircraft. Aerial refueling involves the connecting of a fuel-transmitting medium between a fuel-giving plane and a fuel-receiving plane while both are in mid-air flight. Although this feat has been accomplished in a number of ways over the years, prior art devices and methods have not done so safely without requiring either a high level of skill from the pilot of the fuel-receiving plane or significant structural adaptations or peculiarities to the fuel-receiving plane. The early “crossover” aerial refueling system, for example, involved a fuel-receiving plane dropping a line and a fuel-giving plane also trailing a line with a large hook on the end to catch the fuel-receiving plane's line. Once caught, the fuel-giving plane would reel in the fuel-receiving plane's line and fuel would be transferred. A similar early aerial refueling method, colloquially called the grappled-line looped-hose air-to-air refueling system, involved the fuel-receiving plane trailing a steel cable, which would be grappled by a line shot from the fuel-giving plane, and then drawn into the fuel-giving plane. The fuel-receiving plane would next haul back in its cable along with the fuel-transmitting medium. Next, the fuel-giving plane would climb to a higher elevation and use gravity to transfer the fuel down to the fuel-receiving plane. These early refueling methods and devices, among other limitations, required connecting the refueling nozzle to the fuel-transmitting medium manually and therefore could only be performed at lower elevations—that is, until the creation of an auto-coupling mechanism.

Although various other refueling devices were created to overcome other challenges, the prevailing current aerial refueling methods and devices remain somewhat limited in application. The two most common main refueling systems are the probe-and-drogue system and the flying boom system, but both can only be performed by highly skilled pilots and only on fuel-receiving planes that have been substantially structurally adapted or specifically created for use with such systems. The flying boom system, for example, normally involves a fuel-giving plane (i.e., a tanker) flying ahead of and above a fuel-receiving plane in tight formation. Then, a rigid telescoping tube—a boom, with movable flight control surfaces (usually consisting of two wings and/or airfoils), extends from the back and bottom end of the fuel-giving plane and is maneuvered into position by an operator in the fuel-giving plane through a manual control stick. The desired refueling position of the boom is such that a nozzle and flexible ball joint on the distal end of the boom are inserted into a fuel-receiving receptacle on the fuel-receiving plane, which receptacle is usually located in the top middle and center part of the fuel-receiving plane. Fuel is then transferred through a rigid pipe within the boom. To allow the rigid boom to move with the fuel-receiving plane within a certain envelope, the boom is normally gimbaled. However, if either plane flies outside the “air refueling envelope,” the boom must be quickly disconnected or it could result in boom damage or even a mid-air collision. Great precision is required by both pilots and the boom operator in order to guide the boom into the small opening of the fuel-receiving plane. Furthermore, the structural peculiarities of the boom system require costly adaptations to a fuel-receiving plane. Moreover, although a boom is and generally must be moveable, it is only moveable within a small envelope, which does not include certain areas of the fuselage or wings, and may not be inserted into a fuel-receiving receptacle at certain angles.

The probe and drogue system involves a fuel-giving plane trailing behind it a flexible refueling hose having a drogue disposed at the hose's trailed end. The drogue connects with a probe attached to the fuel-receiving plane, which plane is generally located a short distance behind and below the fuel-giving plane. Drogues usually have a tapered annular parachute-like canopy supported by a plurality of rigid metal ribs (somewhat shaped like a shuttlecock). The narrow end of the drogue may be attached to the flexible hose. The drag created by the drogue pulls the hose out from a reeled position on the fuel-giving plane and toward the fuel-receiving plane. The drogue also provides stability. The pilot of the fuel-receiving plane then guides the plane so that the probe, which is a rigid, protruding or pivoted retractable arm placed on the plane's nose or fuselage, with a valve on the end, is inserted into the drogue. The drogue also acts as a funnel guiding the probe to the drogue's inner receptacle, where the probe attaches to the hose. When refueling is complete, the probe and drogue are disconnected and the hose and drogue are reeled back into a pod in the fuel-giving plane.

Although the probe and drogue method may require less adaptations and specialized structures than the flying boom method, it still normally requires at a minimum that the fuel-receiving plane be equipped with a refueling probe. Such a refueling probe, moreover, must be located either on the nose of the plane or in some more rare cases certain limited areas of the fuselage. The procedure of guiding the probe into the drogue, furthermore, can be challenging for several reasons. First, since the drogue is relatively light, the position of the drogue is influenced by both turbulence and the bow wave of the fuel-receiving plane. Second, both the fuel-receiving plane and the fuel-giving plane are normally moving at very high speeds, yet when completing the required maneuver the fuel-receiving plane must approach the fuel giving plane at a relative speed of just two knots (approximately) faster than the fuel-giving plane, a hardly perceptible difference. Third, the probe can only be pushed into the drogue several feet—a difficult task when moving at such a high speed; any more could damage the probe tip, and any less could result in an incomplete connection, resulting in no fuel flow and/or fuel leakage. Fourth, since the drogue generally does not have the capacity to maneuver with precision, the pilot of the fuel receiving must carefully maneuver in a relatively small area in order to line up the probe with the drogue. If the drogue misses the target probe and instead hits the fuel-receiving plane, it could damage the plane (and/or the plane equipment located around the nose of some planes such as sensitive avionics equipment) and endanger the safety of a pilot and any crew. Due in part to the substantial risks involved, and the high level of skill and concentration required of the pilot of the fuel-receiving plane, the probe-and-drogue system has generally not found application outside of military settings.

A related problem that makes maneuvering the drogue and accurately lining up the probe with the drogue difficult is the high drag coefficient of the hose as it travels through the air, which may result in unpredictable movement, such as oscillating. Although a few devices have been created to ameliorate negative effects caused by disadvantageous hose designs, such prior art devices appear to be limited in application to once a fuel connection has already been established. For example, during fuel transfer, one mechanism placed in the fuel-giving plane measures torque on the hose, and then causes the hose to retract and extend as the fuel-receiving plane moves forward and backward with respect to the position of the fuel-giving plane, thereby reducing slack and preventing bends in the hose, which might otherwise disrupt the connection. However, lining up a probe with a drogue prior to fuel connection nevertheless remains a difficult task, partly due to among other factors unpredictable movements caused by drag on the hose. Another problem of prior art hose designs is that, due to the problems arising from high drag resistance, the cross-sectional size of the hose may be limited. This is turn reduces the amount of fuel that may be transferred through the hose per unit of time, thereby requiring more time for refueling (and increasing the time period that something could go wrong while refueling).

Thus, although the benefits of aerial refueling are well-known, such as allowing an aircraft to remain airborne longer, extending its range, carrying more weight, and reducing fuel consumption on long distance flights, the necessary costs for adapting a plane to be compatible with either the flying boom or the hose-and-drogue systems, combined with the difficulty of precise midair navigation and the specialized skills required for safe handling of the aircraft during refueling, has resulted in limited application, primarily for military purposes. Thus, there is clearly a need in the market for an aerial refueling solution tailored to commercial aviation.

### SUMMARY OF THE INVENTION

Prior art devices methods essentially do not provide sufficient and/or practical solutions for aerial refueling of commercial aircraft, in part due to the necessity of certain structural formalities, and also because of the substantial difficulty of precisely positioning a fuel-transmitting medium to establish a connection between the fuel-giving plane and the fuel-receiving plane while both are in mid-air and traveling at high speeds. If the fuel-receiving plane is not manufactured incorporating such structures, the plane must then have certain adaptations performed, which if even possible can be prohibitively expensive for most commercial applications. A commercial fuel-receiving plane's fuel ports/inlets, for example, may be located in areas where it may not be advisable to attach a probe, or difficult if not impossible for a flying boom to reach. Specifically, many commercial aircraft have fuel inlets/refueling ports located on or under wings or in certain spots along the fuselage that are difficult to connect with a fuel-transmitting medium for several reasons using either the probe and drogue system or the flying boom system.

In the case of the conventional probe and drogue system, for example, a pilot of the fuel-receiving plane must guide the probe into the drogue, which requires a great deal of precise maneuvering by the fuel-receiving plane's pilot, even when the probe is conveniently located at the front tip of a fuel-receiving plane. The task is even more challenging for larger and less maneuverable planes, such as commercial (as opposed to fighter) jets, or when probes are located in other not-so convenient areas of the plane. Attaching probes along the wings, for example, would present several other obvious challenges, such as requiring in some instances that a pilot look to the side at the wing for a significant period of time while the plane is traveling forward at high speeds and in close proximity to the fuel-giving plane. Moreover, since a plane's engines are usually located along the wings, if a probe located along a wing were to miss the drogue while trying to connect, the probe/drogue parts could be ingested into the plane's engines. In addition, some commercial planes simply do not provide good structural accommodation for retrofitting probes on wings or other harder-to-reach areas of the fuselage.

In the case of the flying boom system, although the boom may be said to be “maneuverable,” its range of motion is too limited to allow the boom to reach many parts of the fuel-receiving plane where fuel inlets might be located, such as often the wings. Even if theoretically possible in some instances, the limited orientation of the boom further makes connecting with fuel inlets located on certain areas of the fuel-receiving plane extremely problematic if not impossible. Adding to the difficulty, since the boom operator is generally stationed in the rear-center of fuel-giving plane, in some instances more difficult the vantage point of the boom operator may also make maneuvering the boom to certain areas of the fuel-receiving plane (such as the wing) more challenging. In addition, in the case of the fuel-receiving plane having fuel inlets located on the wings, the fuel-giving plane would likely have to be more laterally offset from the fuel-receiving plane in order for the boom to reach the wings (in order for the boom operator to have a plain sight view of the operation), and therefore, since the nose of the fuel-receiving plane is significantly in front of its wings, the fuel-receiving plane must be farther behind the fuel-giving plane in order to avoid the front end of the fuel-receiving plane colliding with the rear of fuel-giving plane, which further aft position also increases the challenge for the boom operator. Moreover, if the boom were to miss a wing target, the potential impact of the boom against the wing creates added danger.

Described herein is a device, system, and method of aerial refueling for overcoming one or more of the aforementioned disadvantages, which allows precise positioning for connecting a fuel-transmitting medium with an inlet fuel inlet/refueling port located in certain areas of commercial fuel-receiving planes (such as the along the wings). In some instances/embodiments, such a refueling connection may be accomplished without requiring certain adaptations (that are often otherwise required by prior art devices, systems, and methods) to the fuel-receiving plane. The novel method may comprise a fuel-transmitting medium being trailed by a fuel-giving plane, which has at the end of the fuel-transmitting medium a navigable flying unit capable of precise mid-air navigation and fastening to the surface of the fuel-receiving plane and of establishing a connection between the fuel-transmitting medium and the fuel inlet/refueling port located on the plane's surface. In one embodiment and if necessary, the navigable unit is additionally maneuverable along a surface of the fuel-receiving plane.

The navigable flying unit comprises flight control features for achieving precise mid-air navigation and safely positioning the unit with respect to the fuel-receiving plane near the fuel nozzle/refueling port. Said flight control features comprise manipulable aerodynamic surfaces, allowing in-air movement in the important directions to be controllable by an operator. Such flight control features and manipulable aerodynamic surfaces may comprise, for example, retractable wings complimented by horizontal stabilizers and elevators to control pitch, a vertical stabilizer and a rudder to control yaw, flaps for controlling lift, and ailerons for controlling roll. In some embodiments, rather than require a means for internally generating thrust, such precise movement may occur as a result of air passing over the aerodynamic surfaces in predetermined manners, and also due to the velocity attained from being dragged behind the fuel-giving plane (which may simulate thrust to a certain degree). The aerodynamic surfaces may be manipulated, in one embodiment, by actuators connected by wire to a control system in the fuel-giving plane.

Said control system in one embodiment may be configured to relay signals so that the operator may control the navigable unit without requiring a direct line of sight, and may allow such controlling from a remote location other than on the fuel-giving plane. Thus, the method and device described herein may also comprise a means for determining the position of the navigable flying probe unit in relation to the fuel inlet/refueling port located on a surface of a fuel-receiving plane for purposes of guiding the unit with substantial precision to the fuel inlet/refueling port. In one embodiment, said means may comprise a camera attached to the navigable unit with visual signals capable of being relayed to a screen of the navigable unit operator. In another embodiment, the means may comprise a camera mounted to the fuel-receiving plane in a predetermined location (or multiple cameras mounted in several locations), such as near the fuel inlet/fuel/receiving port. In yet another embodiment, the operator may be located in the fuel-receiving plane, and said means for determining the position of the navigable flying probe unit may comprise, in addition to the camera, at least one operator sightline of the probe and the fuel inlet/refueling port. In another embodiment, the means for determining the position of the navigable flying probe unit in relation to the fuel inlet/refueling port may utilize a laser, which beam may assist in indicating the projected position of the navigable unit to the operator. In one embodiment, the flight control components, although controllable by an operator, may be at least partially automated. For example, the position/altitude of the navigable unit may be confirmed by sensor inputs, and signals relaying such location information may be fed into the control system and processed by a computer program, and the operator may control the intended direction of the movement of the navigable unit, with the computer program and automated system receiving the directions/commands of the operator, determining which aerodynamic surfaces should engage and how they should be manipulated using the actuators, and then sending signals for such manipulation accordingly.

The navigable unit may also comprise a means for attaching to the plane's surface, and once properly positioned in sufficient proximity to the fuel inlet/refueling port, the navigable unit may attach to the plane surface surrounding or close to the fuel inlet/refueling port. In one embodiment, the means for attaching to the plane surface may comprise electromagnetic linkage, with an electromagnet on either/both the surface of the fuel-receiving plane and/or the navigable unit, and with the electromagnet strategically placed so that the navigable unit may statically attach (i.e., at least partially fixed) in a desired refueling position. The attaching force of said attachment may vary in some embodiments to allow limited additional movement of the navigable unit along the plane surface, and in one embodiment utilizing electromagnetic linkage said attaching force may be such that if the tension between the fuel transmitting medium and the plane surface (or fuel inlet) increases above a predetermined level (to for example avoid damage to the unit and/or fuel-receiving plane), then the navigable unit may automatically detach/dislodge. In another embodiment, the means for attaching to the plane surface may utilize both electromagnetic linkage and a physical attachment mechanism, with the physical attachment mechanism remains intact in an attached position for the duration of the refueling procedure.

The means for moving the navigable unit along a plane's surface may be used to adjust the navigable unit to a more precise position over the fuel inlet. In one embodiment, said means for plane surface movement may be located on a side of the unit configured to face a surface of the plane and lightly and safely make contact with the surface. Said contact, in one embodiment, may be made using, and said movement means may comprise, ball bearings or wheels for rolling along the plane's surface (which wheels may in some embodiments have a predetermined configuration for facilitating desired movement, e.g., two vertical and two horizontally-aligned potentially omni-directional wheels). In some embodiments, the side of the navigable unit facing the plane surface may also comprise a shape configured for advantageously fitting to said surface and for properly orienting the fuel flow from the attached fuel-transmitting medium into the fuel inlet. For example, the navigable unit may comprise a shape adapted for placement over an aircraft's lower wing surface, and/or a portion thereof adapted to the shape of a fuel inlet located on the wing. Alternatively, in some embodiments the shape of the refueling port may be adapted for engaging with the navigable unit.

The navigable unit may also comprise a means for connecting/coupling to the fuel inlet, as well as a means for opening the fuel inlet (valve). Alternatively, a fuel port comprising a fuel inlet may comprise a means for connecting with the navigable unit and opening the fuel inlet valve (to enable a fuel connection). In one embodiment, by way of example of a means for connecting/coupling to the fuel inlet, once the navigable unit is properly positioned over the fuel inlet, a fuel barrel may extend from the end of the navigating unit facing the plane surface comprising the fuel port (or simply the fuel inlet), and couple/attach to the fuel inlet, locking into position prior to the commencement of fuel flow transfer. In another embodiment, the system described herein may comprise a fuel port that utilizes an adapter for the fuel inlet, which replaces the physical covering on the fuel inlet with an electrically activated and remotely controllable and/or automatic mechanism that may open and close the fuel inlet/refueling port as desired. Similarly, in the case of planes having sections of the wing covering the fuel inlet, in one method embodiment said sections may be replaced with automatic doors (e.g. sectional or rolling). In another embodiment, the refueling port of the fuel-receiving plane may also comprise shear rivets so that if a large amount of tension develops during refueling, the rivets shear and the fuel barrel breaks off rather than suffer structural damage. In another method embodiment, computer controls may be used to regulate the flow of fuel.

The navigable unit may also comprise, in one embodiment, a means for softening the impact of the navigable unit against the plane surface, such as for example a cushion-like feature. For example, in one embodiment, the incoming air along the leading edge of the navigable unit may be channeled to an inflatable canvas designed to have first contact with the plane surface, which inflatable canvas may provide sufficient cushioning to avoid damaging either the plane surface or the navigable unit upon impact. After the initial cushioned impact, the canvas may deflate and thereby facilitate attaching to the plane surface in the manner described above, and also any additional movement of the navigable unit along the plane's surface (as described above). In a related embodiment, the inflation of the inflatable canvas may utilize internal means, such as an air compressor.

Embodiments of the fuel-transmitting medium may vary, but may be flexible in many degrees of freedom, which flexibility might be accomplished in some embodiments using corrugated sections. Furthermore, to transfer a higher volume of fuel more quickly, the cross-sectional area of the hose of the fuel-transmitting medium may be greater than conventional hoses. To make such wider designs more practical and also to reduce drag effects (and also applicable to fuel-transmitting medium embodiments that do not comprise hoses having greater cross-sectional areas), the fuel-transmitting medium may comprise aerodynamic surfaces, which in one embodiment may comprise symmetrical airfoil. The shape of said aerodynamic surfaces are configured to reduce the drag coefficient according to the position and intended configurations of the fuel-transmitting medium while traveling in mid-air and being dragged behind the fuel-giving plane and fastened to the navigable unit. For example, rather than having a shape and a drag coefficient similar to that of a sphere or a cylinder (when the fuel-transmitting medium has some vertical and/or lateral components to its shape with respect to passing air—rather than running directly backward from the fuel-giving plane to the fuel-receiving plane, with respect to the passing air), the shape and drag coefficient may resemble more that of a streamlined body, and may have in one embodiment a plurality of sections of such streamlined bodies/aerodynamic surfaces.

For example, said aerodynamic surfaces may in one embodiment comprise the flexible tubing itself as manufactured in the predetermined cross-sectional design (meaning the fuel in transmitted within the tubing/aerodynamic surfaces), or in another embodiment may comprise light sheath coverings fixed to different sections of the hose, thereby surrounding the hose. In one sheath embodiment, and as described below, the fuel-transmitting medium may also comprise a means for internally centering the hose so that it is more likely to be at the aerodynamic center of the fuel transmitting medium. For example, in one embodiment this may accomplished by using light ball bearing arrangements around the hose. In a related embodiment, a gimbal may be utilized to balance the pitch of each section of hose. Although anticipated as advantageous for use with the navigable device described herein, it is anticipated that the fuel-transmitting medium described herein and embodiments thereof may be beneficial for use with a variety of aerial refueling devices, methods, and systems intended to carry a fuel-transmitting medium from a fuel-giving plane to a fuel-receiving plane for facilitating establishing a fuel connection.

In one anticipated embodiment, the entire aerial refueling process from beginning to end, and/or parts thereof may be computer controlled for autonomous/non-human operator-controlled application. As previously mentioned, the device, system, and method described herein may have particular application for certain types of fuel-receiving planes that are commercial planes. By way of specific example, device, system, and method embodiments may be found beneficial for commercial planes that have employed structural reductions to lower fuel consumption while accepting limitations on range, such as Large Aircraft for Short Range (LASRs).

The above description and listed alternative embodiments are considered that of some embodiments only. It is understood that the embodiments shown in the drawings and described below are merely for illustrative purposes and not intended to limit scope. Alterations and modifications, therefore, and such further applications as would occur to those skilled in the relevant art(s), are also contemplated.

### BRIEF DESCRIPTION OF THE DRAWINGS

FIG. 1 illustrates a navigable unit carrying a fuel transmitting medium from a fuel-giving plane to a fuel-receiving plane.

FIG. 2 is a perspective view of the navigable unit of FIG. 1 utilizing manipulable aerodynamic surfaces to approach a fuel port in the wing of the fuel-receiving plane.

FIG. 3 illustrates a fuel barrel extending from the navigable unit of FIG. 2 towards the fuel port.

FIG. 4 illustrates the fuel barrel of the navigable unit coupling to the fuel port of the fuel-receiving plane.

FIG. 5 illustrates the navigable unit of FIG. 4 being stably positioned for the transmittal of fuel to the fuel-receiving plane.

FIG. 6A illustrates a close up view of a fuel barrel embodiment coupling to the fuel port of the wing of the fuel-giving plane.

FIG. 6B is a cross-sectional view of a fuel transmitting medium embodiment comprising aerodynamic surfaces.

FIG. 7 illustrates a navigable unit embodiment comprising a means for softening impact of the navigable unit against a surface of the fuel-receiving plane.

FIG. 8 illustrates a navigable unit embodiment comprising a means for moving the navigable unit along the plane surface for aligning its position with the fuel port.

### DETAILED DESCRIPTION OF THE PREFERRED EMBODIMENTS

“Fueling port,” “fuel port,” and “refueling port” may all be used interchangeably and are defined herein as an area comprising a fuel inlet for receiving the connecting means of the navigable unit. “Controllable” is also defined to include “manipulable.”

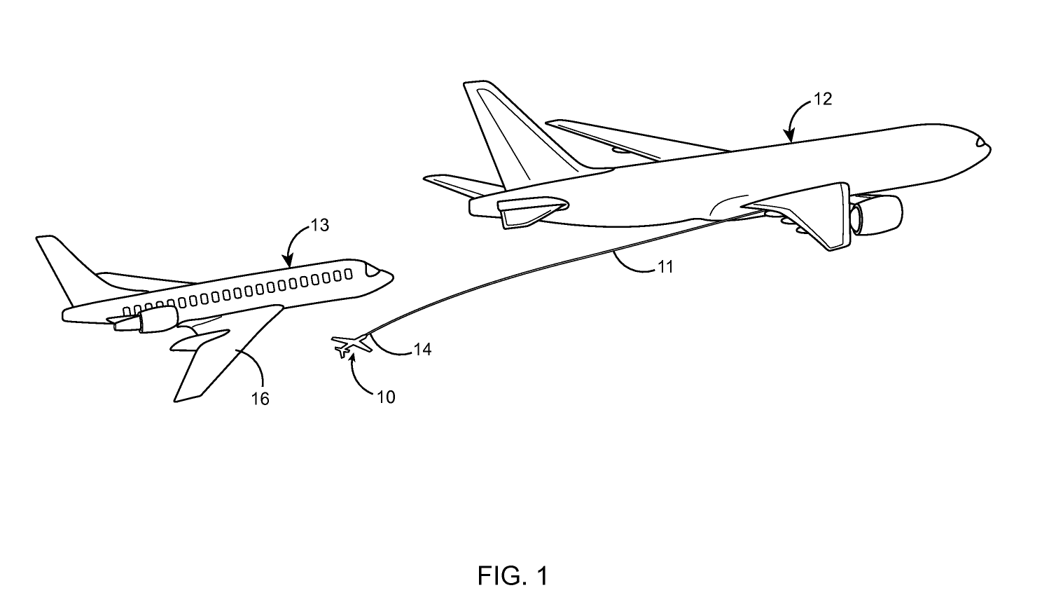

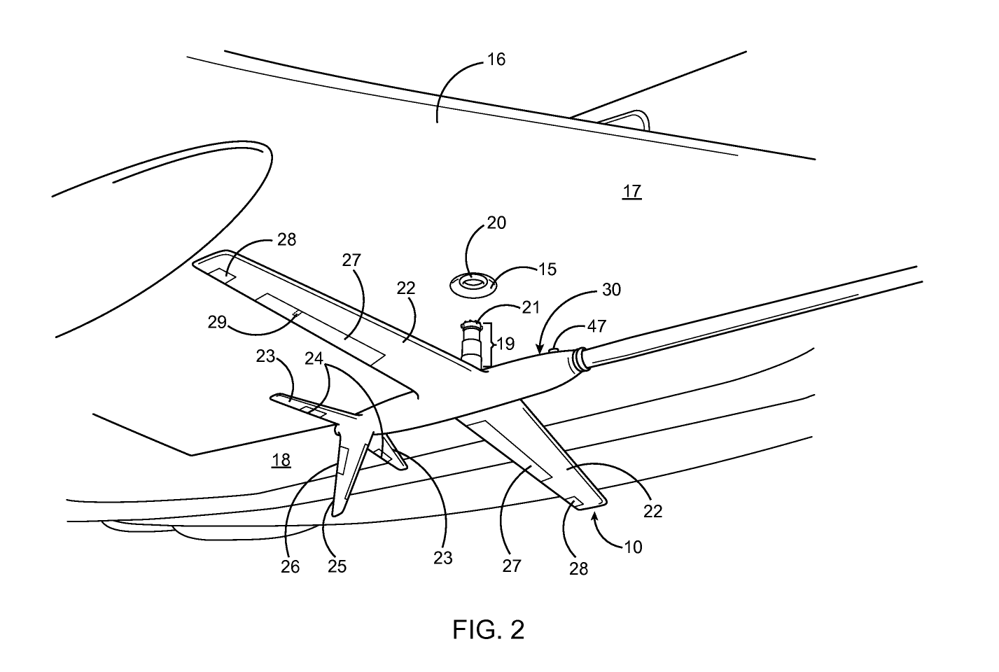

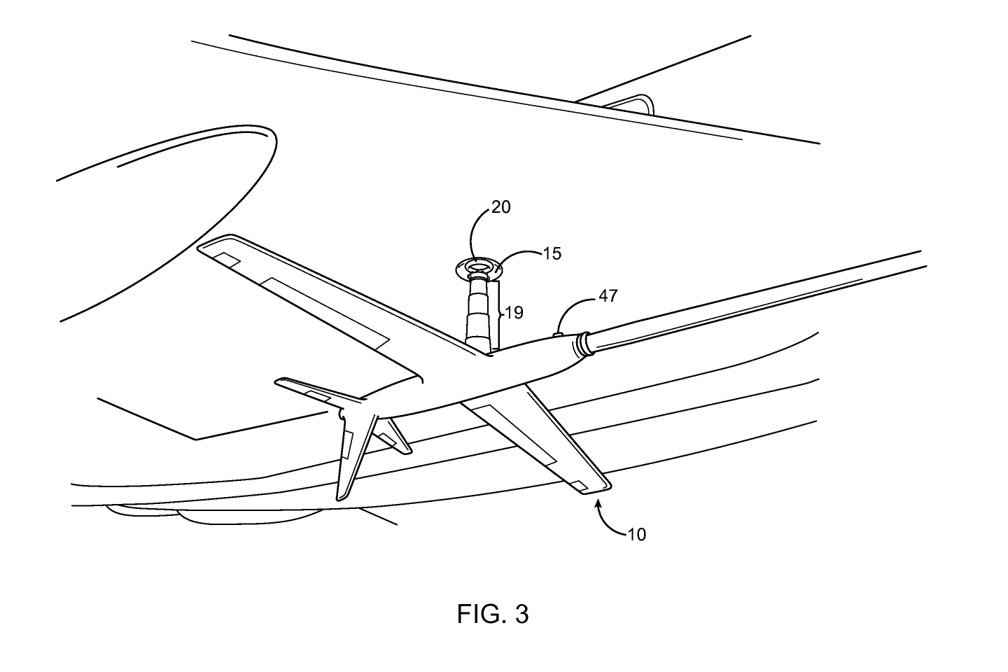

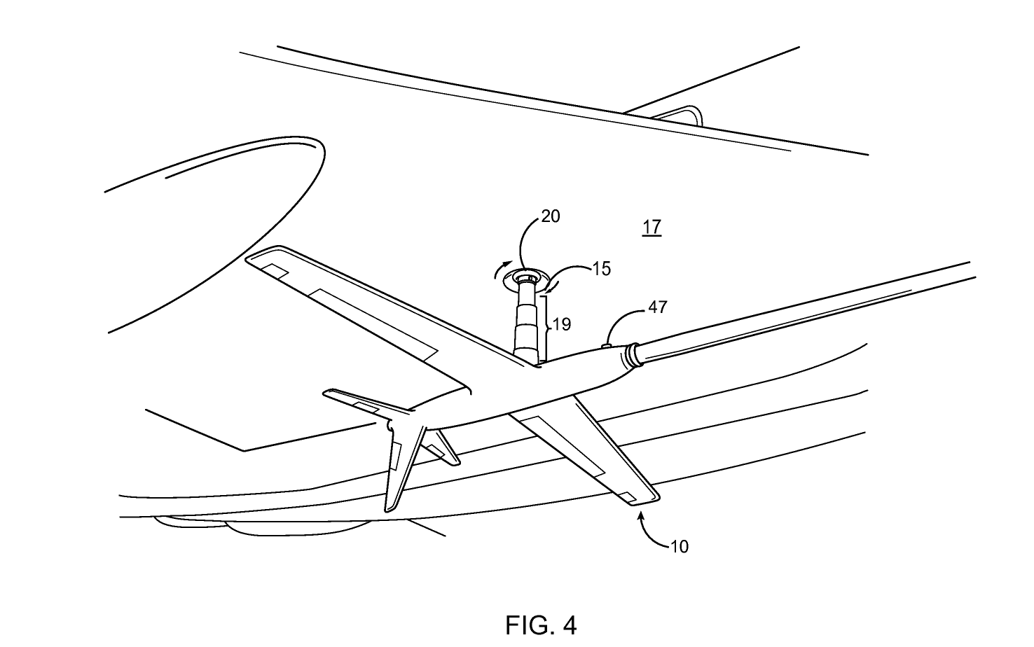

Turning to the drawings, FIG. 1 illustrates a navigable flying probe unit 10 carrying a fuel transmitting medium 11 from a fuel-giving plane 12 to a fuel-receiving plane 13, and also a method of aerial refueling comprising trailing said fuel-transmitting medium 11 from the fuel-giving plane 12, and maneuvering it 11 through the air towards the wing 16 of the fuel-receiving plane 13 using, on one end 14 of the fuel-transmitting medium 11, the navigable unit 10, and (as also shown in FIG. 2) by utilizing the navigable unit's 10 controllable aerodynamic surfaces 18 to precisely position the navigable unit 10 to the refueling port 15 located on the surface 17 of the wing 16 of the fuel-receiving plane 13. Then, as shown in FIGS. 3-4, a fuel connection may be established by a means for connecting/coupling to a fuel inlet 20, by extending a fuel barrel 19 from the navigable unit 10 and connecting the fuel barrel 19 with the fuel inlet 20 of the refueling port 15 for transmitting fuel from the fuel-giving plane 12 to the fuel-receiving plane 13 (FIG. 1). As shown in FIG. 2, the navigable unit 10 the means for connecting/coupling may also comprise a means for releasably attaching 21 to a surface 17 of the fuel-receiving plane 13 (FIG. 1), which (as in the embodiment shown) may comprise the fuel barrel 19 or features thereof for coupling to the fuel inlet 20 of the fuel-receiving plane 13.

The controllable aerodynamic surfaces 18 (e.g., flight control features) for precisely positioning the navigable unit 10 in-air to the fuel-receiving plane 13 and certain parts thereof where the fuel port 15 may be located, may comprise in one embodiment manipulable wings 22, which in one embodiment may be retractable, and which may be complimented by horizontal stabilizers 23 and elevators 24 to control pitch, a vertical stabilizer 25 and a rudder 26 to control yaw, flaps 27 for controlling lift, and ailerons 28 for controlling roll. The navigable flying probe unit 10 need not be required to comprise a means for internally generating thrust, and may instead utilize air passing over its surfaces due to its velocity from being dragged behind the fuel-giving plane 12 (FIG. 1) may simulate thrust to a certain degree. The aerodynamic surfaces 18 may be manipulated, in one embodiment, by actuators 29 (only one of which actuators internal to the unit 10 is shown, although there may be many and at least one for each of the manipulable aerodynamic surfaces 18), which may allow in-air movement of the unit 10 to be controllable by an operator, which in the embodiment shown may view the position of the navigable unit 10 with respect to the fuel-receiving plane 13 and fuel port 15 thereof through a camera 47 strategically mounted to the top surface 30 of the navigable unit 10 to provide a view of the relevant operations and positioning. The side 30 of the navigable unit 10 facing the plane surface 17 may also comprise a shape configured for for fitting to said surface 17 (which may assist in avoiding inadvertent impact).

Once the navigable unit 10 is properly positioned near the fuel port 15, in the embodiment shown in FIG. 3, the fuel barrel 19 may extend from the navigable unit 10 towards the fuel port 15. Then, (if necessary) once the navigable unit 10 is additionally extended or properly positioned in-air, or once the fuel barrel 19 is properly positioned along the surface 17 of the wing 16 in sufficient proximity to the fuel inlet 20 of the refueling port 15, the navigable unit 10, or rather (in the embodiment shown) the fuel barrel 19 of the navigable unit 10, may attach to the plane surface 17 surrounding or close to the refueling port 15 and/or the fuel inlet 20. Said additional positioning may in one embodiment also be controlled by an operator with the assistance of a camera 47 mounted to the surface 30 of the navigable unit 10, with visual signals being relayed to the location of the operator, or may occur automatically with the assistance of a computer.

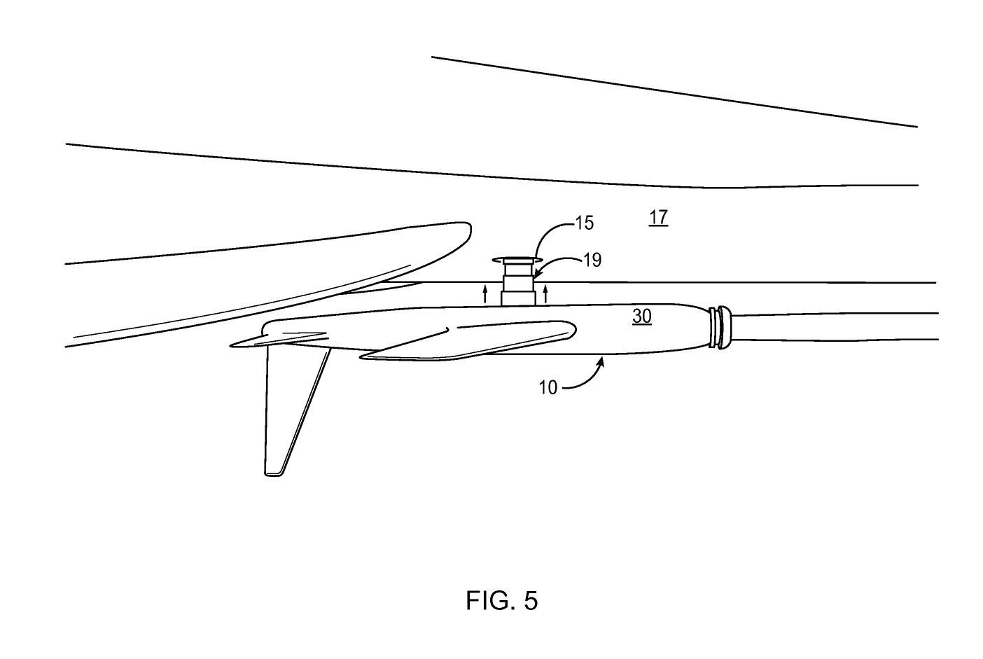

Next, once precisely and properly positioned next to the refueling port 15, as shown in FIG. 4, the navigable unit 10 may releasably attach to the plane surface 17 and the fuel barrel 19 may couple with the fuel inlet 20, which may be opened (and closed) in the embodiment shown by a twisting mechanism in preparation for fuel being transmitted there through. Once the fuel barrel 19 of the navigable unit 10 is attached to the fuel port 15 and/or the fuel inlet 20, the navigable unit 10 may also then be positioned in a more stable configuration for the transmission of fuel, as shown in FIG. 5. For example, in the embodiment shown, the fuel barrel 19 may retract its length so that the surface 30 of the navigable unit 10 is closer to the wing surface 17 surrounding the fuel port 15, or may be moved to some other preferable position for decreasing wind resistance. With the navigable unit 10 in said more stable position, and a connection having been established between the fuel inlet 20 of the fuel port 15 (FIG. 4) and the fuel barrel 19, fuel may be transmitted from the fuel-giving plane 12 to the fuel-receiving plane 13 through the fuel transmitting medium 11 (FIG. 1).

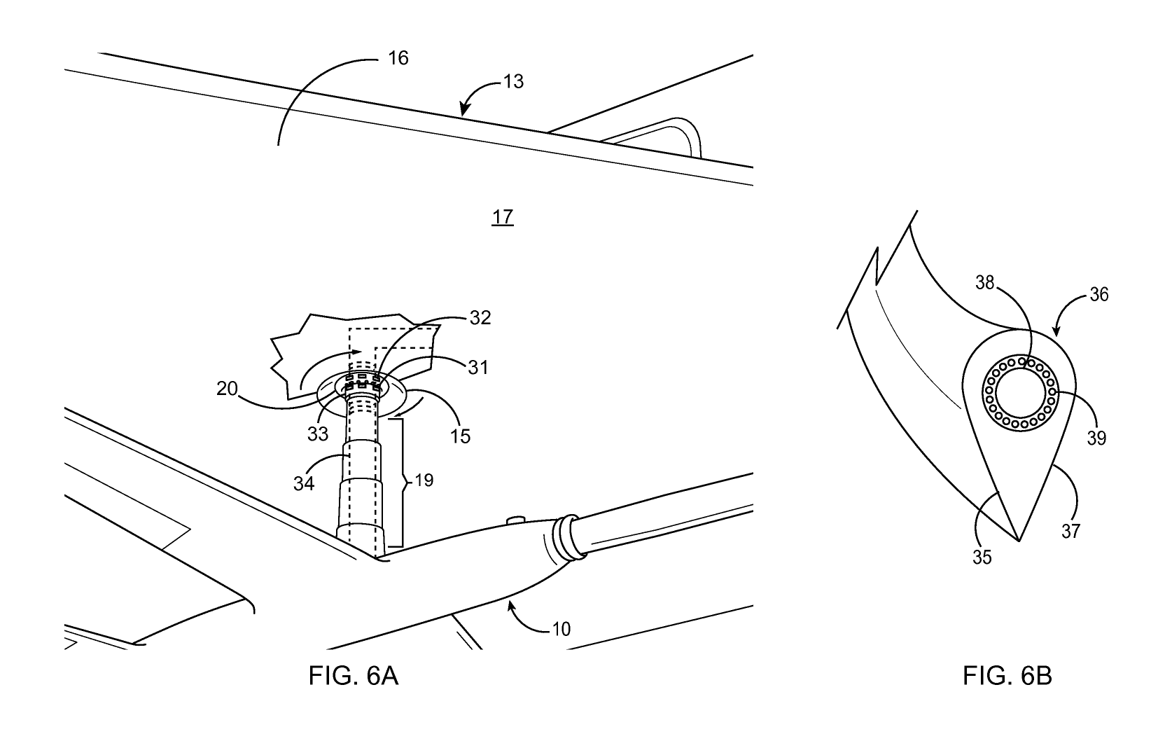

The navigable flying probe unit 10 may also comprise a means for precisely positioning the navigable unit 10, and/or the fuel barrel 19 of the navigable unit 10 along the surface 17 of the wing 16, and to more easily attach and/or lock onto the refueling port 15 and/or the fuel inlet 20. As shown in FIG. 6A, in one embodiment said means may comprise the fuel barrel 19 but on its end 33 having a plurality of ball bearings 31 for rollably engaging the surface 17 of the wing 16 or the refueling port thereof 20 to become more precisely positioned so that refueling can take place. Said means may also utilize electromagnetic linkage, with a plurality of electromagnets 32 on either/both the surface 16 of the wing 17 of the fuel-receiving plane 13 and at the fuel port 15, and/or the navigable unit 10, or rather the tip 33 of the fuel barrel 19 so that the electromagnetic force assists in guiding the tip 33 of the fuel barrel 19 to the proper position opposite the fuel port 15 for coupling with the fuel inlet 20. When, with the assistance of the aforementioned means for positioning the navigable unit 10 along the surface 17, the fuel barrel 19 is precisely positioned in the predetermined location along the surface 17 corresponding to the refueling port 15, the fuel barrel 19 may couple to the fuel inlet 20 of the fuel port 15, so that fuel may be transmitted through the fuel barrel 19 (and possibly through a hose 34 internal to the fuel barrel 19) and into the fuel inlet 20.

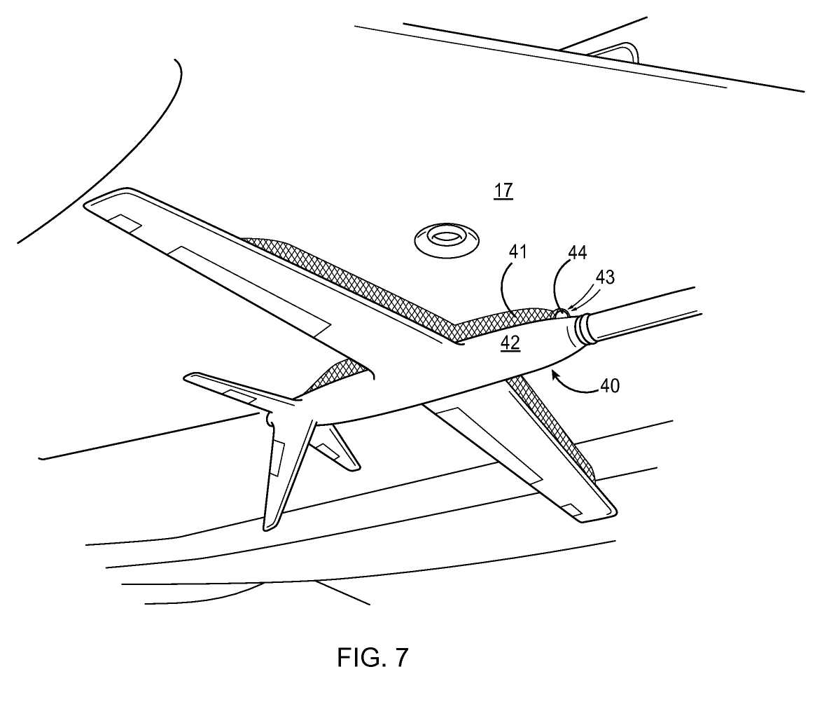

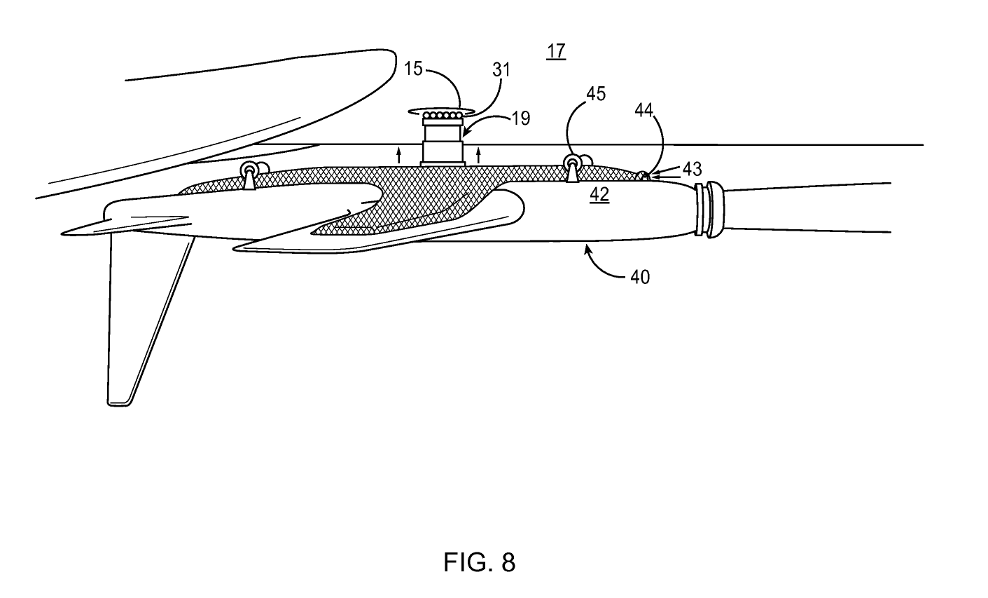

One navigable unit embodiment 40, as shown in FIG. 7, may further comprise a means 41 for safely softening impact of a surface 42 of the navigable unit 40 against the surface 17 of the wing 16 of the fuel-receiving plane 13 (FIG. 1). In the embodiment shown in FIG. 7, said means 41 may comprise an inflatable canvas 41 designed to have first contact with the plane surface 17 (prior to extension of the fuel barrel 19, shown in FIG. 3), the canvas 41 providing sufficient cushioning to avoid damaging either the plane surface 17 or any surface 42 of the navigable unit 40. The inflatable canvas 41 may inflate by the channeling of incoming air 43 into an aperture 44 along the leading edge of the navigable unit embodiment 40, and then (after damage of the plane surface 17 and/or the surface 42 of the navigable unit 40 has been averted by contact of the inflatable canvas 41 against the plane surface 17) the canvas 41 may deflate, as shown in FIG. 8, thereby allowing attaching to the plane surface 17, and also if necessary allowing movement of the navigable unit embodiment 40 along the plane's surface 17. More specifically, rotatable wheels 45 mounted to the fore and aft of the navigable unit 40 may assist in the navigable unit 40 roll or slide along the plane surface 17, and also once the fuel barrel 19 extends towards the fuel port 15, (as mentioned above) motorized and controllable wheels or bearings 31 along the end of the fuel barrel 19 may also assist in positioning the fuel barrel 19 in the correct position opposite the fuel port 15.

In one embodiment, in-air movement of the fuel transmitting medium 11 (as shown in FIG. 1) may be facilitated by not only the navigable unit 10 but also by, in one embodiment, drag-reducing aerodynamic surfaces 35 of the fuel transmitting medium embodiment 36, a cross-section of which is shown in FIG. 6B (which aerodynamic surfaces may comprise symmetrical airfoil having a shape for displacing air in a predetermined manner), and may have a substantially teardrop shape. Although as mentioned above one embodiment may be intended to allow fuel to flow/be transmitted within the cavity formed by the aerodynamic surfaces, the fuel transmitting embodiment 36 shown comprises a light sheath covering 37 fixed around the hose 38, which hose 38 may be capable of being centered at the aerodynamic center of the fuel-transmitting medium embodiment 36 as it travels in-air. This centering may occur in the embodiment shown utilizing a plurality of light ball bearings 39 arranged around the hose 38.

I claim:

1. A navigable device for carrying a fuel transmitting medium from a fuel-giving plane to a fuel inlet of a fuel-receiving plane, the fuel inlet surrounded by a plane surface, the device comprising:
controllable aerodynamic surfaces for navigating the device to a midair position in close proximity to the fuel inlet;
a means for releasably attaching to the plane surface close to the fuel inlet; and
a means for coupling to the fuel inlet for establishing a fuel transmitting connection;
wherein, by controlling the aerodynamic surfaces, the navigable device is maneuverable to the fuel-receiving plane and releasably attachable to the plane surface surrounding the fuel inlet; and
wherein, once the navigable device is attached to the plane surface, it couples with the fuel inlet so that fuel transfers through the fuel transmitting medium from the fuel-giving plane and to the fuel receiving plane.

2. The device of claim 1, further comprising a side configured for facing the plane surface surrounding the fuel inlet and comprising the means for coupling to the fuel inlet.

3. The device of claim 2, wherein the means for coupling to the fuel inlet comprises a fuel barrel.

4. The device of claim 3, wherein the fuel barrel comprises an end configured to face the fuel inlet when the navigable device is in close midair proximity to the fuel inlet.

5. The device of claim 4, wherein the fuel barrel is extensible and retractable.

6. The device of claim 5, where the fuel inlet is comprised by a fuel port located on the plane surface surrounding the fuel inlet, and the fuel barrel is configured to releasably attach to the fuel port.

7. The device of claim 1, wherein the aerodynamic surfaces comprise retractable wings and stabilizers.

8. The device of claim 7, further comprising actuators for manipulating the aerodynamic surfaces.

9. The device of claim 8, further comprising a means for relaying control signals for controlling the device remotely.

10. The device of claim 9, wherein the means for relaying control signals comprises a camera mounted to the navigable unit.

11. The device of claim 1, wherein the means for releasably attaching to the plane surface utilizes electromagnetic forces.

12. The device of claim 2, wherein the side facing the plane surface surrounding the fuel inlet further comprises a means for moving the navigable unit along the plane surface.

13. The device of claim 12, wherein the means for moving the navigable unit along the plane surface comprises wheels.

14. The device of claim 4, wherein the fuel barrel end comprises ball bearings for adjusting the position of the fuel barrel along the plane surface for properly aligning the fuel barrel end with the fuel inlet.

15. The device of claim 1, further comprising a means for softening impact of the device against the plane surface.

16. The device of claim 15, wherein the means for softening the impact is cushion-like.

17. The device of claim 16, wherein the cushion-like means for softening impact comprises an inflatable canvas.

18. The device of claim 16, where the cushion is inflatable using air passing by the device at a high speed.

19. The device of claim 16, wherein the inflated cushion is deflatable.

20. A fuel-transmitting medium having two ends, a first end connectable to a fuel-giving plane and a second end connectable to a device for facilitating establishing a fuel connection with a fuel-receiving plane, the device for facilitating establishing a fuel connection and the fuel-transmitting medium both configured to be trailed behind the fuel-giving plane during midair flight, the fuel-transmitting medium comprising:
A drag-reducing shape for reducing the drag coefficient while the fuel-transmitting medium is connected at the second end to the device for facilitating establishing a fuel connection and being trailed from the first end by the fuel-giving plane and traveling in midair at a high speed.

21. The fuel-transmitting medium of claim 20, further comprising airfoil cross-sections.

22. The fuel-transmitting medium of claim 21, wherein the airfoil cross-sections are substantially symmetrical.

23. The fuel-transmitting medium of claim 22, wherein the drag-reducing shape has a teardrop shaped cross section.

24. The fuel-transmitting medium of claim 20, further comprising an inner hose, an outer sheath covering the inner hose, and a means for centering the inner hose within the outer sheath to the aerodynamic center of the fuel-transmitting medium.

25. The device of claim 24, wherein the outer sheath comprises corrugated sections.

26. The device of claim 25, wherein the corrugated sections comprise symmetrical airfoil sheath.

27. The device of claim 24, wherein the means for centering the hose comprises ball bearings surrounding the hose.

28. The device of claim 24, wherein the means for centering the hose comprises gimbals for assisting in controlling pitch.

29. A system of aerial refueling, the system comprising:
A fuel-receiving plane comprising a fuel inlet and surrounding plane surface;
A fuel-transmitting medium having a first end and a second end;
A fuel-giving plane configured to trail the fuel-transmitting medium from the first end thereof;
A navigable unit configured to fasten to the second end of the fuel-transmitting medium, and comprising controllable aerodynamic surfaces for precise mid-air navigating;
Wherein, the fuel-transmitting medium is trailed from the fuel-giving plane by the first end of the fuel-transmitting medium, and attached by the second end to the navigable unit, and the navigable is also thereby trailed from the fuel-giving plane; and
Wherein, using the aerodynamic surfaces the navigable unit is maneuverable to a position of close proximity with the fuel inlet and surrounding plane surface of the fuel-receiving plane.

30. The system of claim 29, wherein the navigable unit further comprises a means for releasably attaching to the plane surface, and a means for coupling to the fuel inlet for establishing a fuel-transmitting connection.

31. The system of claim 30, wherein the fuel inlet is comprised by a fuel port adapted to receive the means for coupling to the fuel inlet.

32. The system of 31, wherein the means for coupling to the fuel inlet comprise a fuel barrel and the fuel port is adapted to receive the fuel barrel.

33. A method for the aerial refueling of a fuel-receiving plane by a fuel-giving plane using a fuel-transmitting medium and a navigable unit fastened thereto, the fuel-receiving plane having at least one fuel inlet surrounded by a plane surface, the navigable unit comprising controllable aerodynamic surfaces for mid-air navigating, a means for releasably attaching to the plane surface, and a means for coupling to the fuel inlet(s) of the fuel-receiving plane for establishing a fuel-transmitting connection, the method comprising the following steps:
the fuel-giving plane trailing the fuel-transmitting medium and the navigable unit fastened thereto;
the navigable unit being navigated near to the fuel receiving plane using the controllable aerodynamic surfaces;
the navigable unit releasably attaching to the plane surface surrounding the fuel-receiving plane's fuel inlet;
the means for coupling to the fuel-receiving plane's fuel inlet coupling thereto to establish a fuel-transmitting connection.

34. The method of claim 33, wherein the step of the navigable unit releasably attaching to the plane surface surrounding the fuel-receiving plane's fuel inlet includes utilization of a means for softening impact of the navigable unit against the plane surface.

35. The method of claim 34, wherein the step of the navigable unit releasably attaching to the plane surface includes utilizing electromagnetic forces.

36. The method of claim 35, wherein the navigable unit further comprises a means for moving along the surface of fuel-receiving plane surrounding the fuel inlet, and the method further comprises the step of the navigable unit moving along the plane surface into a position for more precisely coupling with the fuel inlet.
